(19) United States
(12) Patent Application Publication
(10) Pub. No.: US 2008/0063756 A1
(43) Pub. Date: Mar. 13, 2008

(54) Method of preparing an on-site ice cream utilizing very low temperature stainless steel plate

(76) Inventor: Seungbok Jin, Cypress, CA (US)

Correspondence Address: Eugene Oak, Ph. D., J.D., M.Div., 610S. Van Ness Ave., Los Angeles, CA, 90005, US

(21) Appl. No.: 11/517,606

(22) Filed: Sep. 8, 2006

(51) Int. Cl. A23G 9/00

(52) U.S. Cl. 426/101

(57) ABSTRACT

A method of providing an on-site ice cream, comprise of all natural ingredients, in front of a customer is comprised of; 1) trimming step, 2) blending step, 3) cold plate processing step, 4) aeration step, and 5) serving step. Fruits selected by the customer, milk, cream powder and honey syrup are mixed and ground to a slurry state in an electric mixer. Slurry of the mixture from the electric mixer is dumped on the stainless steel plate, which is maintained at the very low temperature between −31° C. to −35 ° C. The slurry freezes very quickly. While the slurry turns into ice, it is folded and cut for 40 to 60 seconds to allow air entrapped in the freezing texture of the slurry. The method of preparing an on-site ice cream according to current invention enables a control of softness of the ice cream without alternating the amount of the cream introduced but by just adjusting the scrambling time. Surprisingly, current invention enables apple ice cream, which is impossible to make by conventional ice cream making methods.

### 1. FIELD OF THE INVENTION

Current application relates with a method of proving an on-site ice cream comprises of a variety of natural ingredients and, especially related with a method of utilizing of a cold stainless plate maintained at temperatures between −31° C. to −35° C.

1. Background of the Invention

Ice cream is a frozen dairy dessert product that has a minimum of 10% milk fat, 9-12% milk solids: 12-16% sweeteners: 0.2-0.5% stabilizers and emulsifiers, 55%-64% water which comes from milk solids or other ingredients. These ingredients, along with air incorporated during the stirring process, make up ice cream.

Generally, less expensive ice creams contain lower-quality ingredients, and more entrapped air, sometimes as much as 50% of the final volume. Artisan-produced ice creams, such as Berthillon's, often contain very little air, although some is necessary to produce the characteristic creamy texture of the product. Generally speaking, the finest ice creams have between 3% and 15% air.

The mouth feel of softness of ice cream depends not only on the contents of the milk fat, but also depends on the contents of the air. The use of stabilizers rather than actual cream and the incorporation of entrapped air also decrease the fat and caloric contents of less expensive ice creams, making them more appealing to those on diets.

The combination of rigid consumer acceptance criteria, regulatory standards and the complex nature of the interactions which produce an acceptable frozen dessert product, make it difficult to formulate an aerated frozen dessert having improved characteristics, particularly when formulating a reduced or non-fat product containing only natural components and ingredients without added traditional stabilizing gums.

It is particularly desirable for frozen dessert products to be stable against “heat shock,” which is cyclic conditions of partial thawing and refreezing which occur during typical storage, shipping and handling of frozen dairy desserts. These cycles of fluctuating temperatures promote ice crystal growth in the dessert product, and a resultant gritty texture to the product. The gritty texture and mouth feel, and diminished appearance detract from the overall general quality of the product.

Stabilizing gums and emulsifiers have been used in an attempt to improve the heat shock stability of frozen food products. Examples of stabilizing gums which have traditionally been used in ice cream include gum acacia, guar gum, locust bean gum, carrageenan, and the like.

Commercially available emulsifiers are generally derived by chemical reaction with naturally occurring glycerides.

It is purpose of the current application to provide a method of preparing an on-site ice cream in front of a customer, which is comprise of all natural ingredients and controls the mouth feel of softness by adjusting scrambling time without changing the contents of fats. Another purpose of the current application is to provide an apple flavored ice cream, which was impossible to make by the conventional ice cream making method.

2. Description of the Prior Art

U.S. Pat. Nos. 3,800,036, and 3,809,764 to Gabby et al., illustrates frozen desserts including ice milk and imitation ice cream having no triglyceride fat ingredient or optionally up to 7 percent by weight of fat can be prepared by employing as texturizing ingredient 0.5 to 1.5 percent by weight of a polyglycerol ester. From 0.05 to 0.5 percent by weight of a hydrophilic colloid stabilizer is optionally employed.

U.S. Pat. No. 4,552,773 to Kahn et al. illustrates a whipped food products comprised of an oil-in-water emulsion of nonfat milk solids, and about 40% to about 70% water, and sugar in a ratio to water of about 1:1.75 to about 3.0; and about 3% to about 10% fat, and minor, effective amounts of flavoring, emulsifier, and stabilizer. The product is substantially noncrystalline and spoon able at about 0° F., and the volume of the product remains substantially constant during storage at about 0° F. for at least about six months.

U.S. Pat. No. 4,400,405 to Morley, et al. illustrates low fat aerated frozen soft-serve dairy desserts containing high levels of stabilizers, emulsifiers and polyhydric alcohols are provided.

U.S. Pat. No. 4,497,841 to Wudel, et al. illustrates reduced fat, aerated frozen dairy desserts prepared with added whey protein concentrate to partially replace the milk solids non-fat, and containing fructose rather than sucrose as the sweetening agent, with added emulsifiers and stabilizers to improve the body and texture of the frozen desserts.

U.S. Pat. No. 4,874,627 to Greig, et al. discloses non-fat frozen dairy dessert compositions which incorporate stabilizers and contain at least some caramelized milk solids. U.S. Pat. No. 3,345,185 to Pisani, et al. In combination with stabilizers, high levels of corn syrup solids have been added to low-fat frozen dessert compositions in an attempt to avoid lactose crystallization and overcome sandiness from high lactose levels. G.B. Pat. No. 1,444,143 to Aktiengesellschaft de Danske Sukkerfabrikker discloses preparing frozen desserts by subjecting skim milk or whey concentrate to ultra-filtration to concentrate the milk solids and reduce the ratio of lactose to milk protein, with the addition of stabilizers and emulsifiers to the dessert compositions

U.S. Pat. No. 5,175,013 to Huang, et al. illustrates a compositions which are capable of being converted to frozen dairy dessert products, including ice cream and yogurt desserts, which have organoleptic qualities comparable to high fat frozen desserts such as ice cream. The compositions are either aerated or quiescently frozen. The dessert products are highly stable to heat shock with a high degree of creaminess. The compositions are composed of a source of milk protein, sweetening agent, partially hydrolyzed starch, and water. Preferably, the compositions are composed of only natural ingredients without added stabilizing gums. Also provided is a method of making the frozen dairy dessert products and a method of preparing a yogurt premix for preparing aerated frozen yogurt desserts. None of the prior arts illustrates a method of providing an on-site ice cream, comprise of all natural ingredients, in front of a customer utilizing a stainless steel plate, which is maintained at very low temperature between −31° C. to −35° C. to control softness of the ice cream without alternating the amount of the cream introduced but by just adjusting the scrambling time and enables an apple ice cream.

### SUMMARY OF THE INVENTION

Ice cream is a frozen dairy dessert products that have minimum of 10% milk fat, 9-12% milk solids: 12-16% sweeteners: 0.2-0.5% stabilizers and emulsifiers, 55%-64% water which comes from milk solids or other ingredients. Generally, less expensive ice creams contain lower-quality ingredients, and more air, sometimes as much as 50% of the final volume. Artisan-produced ice creams, such as Berthillon's, often contain very little air, although some is necessary to produce the characteristic creamy texture of the product. Generally speaking, the finest ice creams have between 3% and 15% air. The mouth feel of softness of ice cream depends not only on the contents of the milk fat, but also depends on the contends of the air. The use of stabilizers rather than actual cream and the incorporation of air also decrease the fat and caloric content of less expensive ice creams, making them more appealing to those on diets. However, customers prefer natural cream. But, it is very hard to make on-site ice cream with natural cream. It is the purpose of the current application to develop a method of providing an on-site ice cream, comprise of all natural ingredients, in front of a customer. The method of providing an on-site ice cream utilizes a stainless steel plate, which is maintained at very low temperature between −31° C. to −35° C. Fruits selected by the customer, milk, cream powder, eggs and honey syrup are mixed and ground to a slurry state in an electric mixer. Slurry of the mixture from the electric mixer is dumped on the stainless steel plate, which is maintained at the very low temperature, for aeration. The slurry freezes very quickly. While the slurry is scrambled for 40 to 60 seconds, air is entrapped in the freezing texture of the slurry. The method of preparing an on-site ice cream according to current invention enables a control of softness of the ice cream without alternating the amount of the cream introduced but by just adjusting the scrambling time.

### BRIEF DESCRIPTION OF THE DRAWINGS

FIG. 1 is a schematic flow chart of the procedure for providing an on-site ice cream, comprise of all natural ingredients, in front of a customer according to current invention.

### DETAILED DESCRIPTION OF THE PREFERRED EMBODIMENT

Recently, harmfulness of artificial stabilizer and flavor essence added into the ice cream to human body is well known to public. As a result, customers prefer natural ingredients rather than artificial ingredients. However, it is impossible to produce an ice cream with only natural ingredients according to previous methods. In addition to this, due to chemical reactions that occurs during heating and freezing processes involved in the prior method, kind of flavors that can be put into the ice cream is limited. For example, it is impossible to make an apple ice cream according to previous method though many people like the flavor and taste of an apple.

Method of making ice cream according to current application, described below, diversifies selection of fruits.

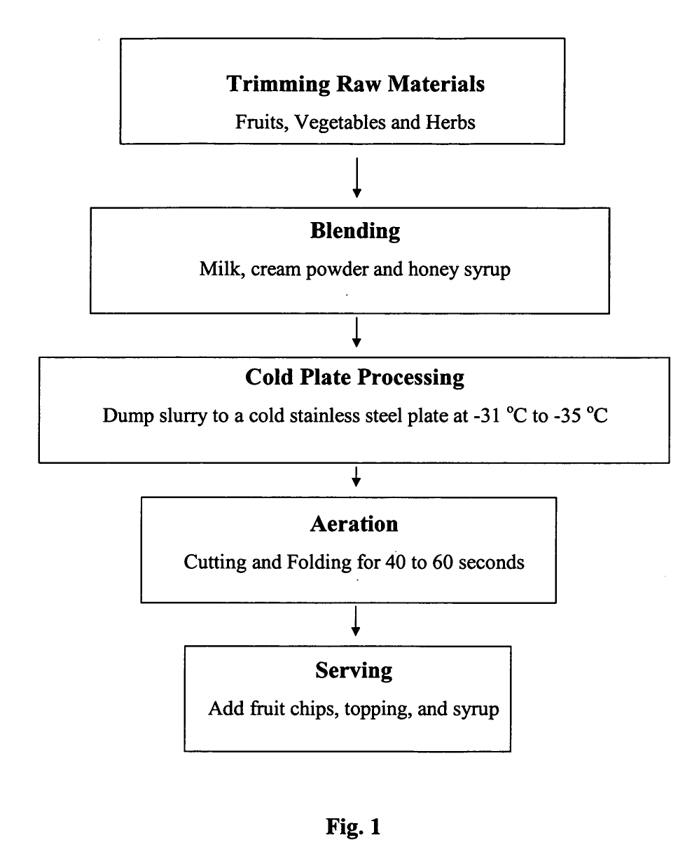

FIG. 1 is a schematic flow chart of the procedure for providing an on-site ice cream, comprise of all natural ingredients, in front of a customer according to current invention.

### Trimming Step:

First step is to trim raw materials, for example; peel off the skin of fruits, such as banana, pine apple, apple, and melon; take out seeds of grape, apple, pear; and cut into small chips. Not only fruits but also vegetables and herbs are possible to be made as an ice cream according to the current invention.

### Blending Step:

After the fruits are trimmed for grinding, put the fruit chips into a mixer with milk, natural cream powder, and honey syrup. Composition of each material in the mixture of the above and additional additives is adjusted according to customer's request. However, total composition of natural cream powder and additives are maintained lower than 1 wt %.

Grind the mixture at least for 30 seconds to form slurry until the texture of the solid material of fruits, herbs, and vegetables are ground into particles smaller than 1 mm diameter.

### Cold Plate Processing Step:

Dump the slurry onto a stain less steel plate, which is maintained at temperatures between −31° C. to −35° C. (The stainless steel plate is maintained at such low temperature by allowing freezing medium flow under the plate. The instrument is described in another application.)

About 1 liter (3 times of 12 oz scoops) of the slurry is dumped on the plate at one time. As soon as the slurry is dumped on the cold stainless steel plate, it starts to freeze. If leave the slurry on the cold plate over 20 seconds it turns to totally frozen ice.

### Aeration Step:

Air contents entrapped in the texture of the ice cream controls soft mouth feel of the ice cream. Just after the slurry is poured on the cold plate, spread and make the slurry as a thin plate with a spatula. The air contents entrapped in the ice cream texture is controlled by cutting, folding and turning over the thin plate of the slurry. Since the temperature of the cold plate is very low, the aeration motion described above should be done continuously. Total aeration time is in the range of 30 seconds to 60 seconds depending on the customer's request.

### Serving:

Any kind of topping and syrup can be added to the ice cream. Sometimes pieces of fruits are dipped in the ice cream.

It is clear that modification of preparing ice cream utilizing a solid plate which is maintained at very cold temperatures is easy according to current application.

What is claimed is:

1. A method of providing an on-site ice cream, comprise of all natural ingredients, especially with apple, herb and vegetables which are impossible to make as an ice cream with prior methods, in front of a customer is comprised of:
trimming step of peeling off the skin of fruits including vegetables and herbs, take out seeds, and cut into small chips, and
blending step of putting the fruit chips into a mixer with milk, natural cream powder, and grind the mixture at least for 30 seconds until the texture of the solid materials are chopped into particles smaller than 1 mm diameter, and
cold plate processing step of dumping about 1 liter of the slurry onto a stain less steel plate, which is maintained at temperatures between −31° C. to?−35° C., at one time, and
aeration step of cutting, folding and turning over a thin plate of the slurry for 30 seconds to 60 seconds depending on the customer's request, and
serving step of adding pieces of fruits, topping and syrup to the ice cream.
